(19) United States
(12) Patent Application Publication
(10) Pub. No.: US 2025/0223391 A1
(43) Pub. Date: Jul. 10, 2025

(54) IMPACT COPOLYMER POLYPROPYLENE COMPOSITION AND MOLDED ARTICLE OBTAINED FROM SUCH COMPOSITION

(71) Applicant: THAI POLYETHYLENE CO., LTD., Bangkok (TH)

(72) Inventors: Pimsai TANPHIBAL, Rayong (TH); Saranya TRAISILANUN, Rayong (TH); Sikann TAMIYAKUL, Royong (TH)

(73) Assignee: Thai Polyethylene Co., Ltd., Bangkok (TH)

(21) Appl. No.: 18/566,423

(22) PCT Filed: Jun. 1, 2022
(86) PCT No.: PCT/IB2022/055117

§ 371 Date: Dec. 1, 2023

(30) Foreign Application Priority Data
Jun. 1, 2021 (TH) 2101003160

(51) Int. Cl. C08F 255/00

(52) U.S. Cl. CPC C08F 255/00

(57) ABSTRACT

The present invention relates to an impact copolymer polypropylene composition comprising a polymer matrix which is selected from propylene homopolymer, propylene copolymer, and a mixture thereof; and an ethylene-propylene rubber phase dispersed in the polymer matrix, wherein the ethylene-propylene rubber phase is in an amount ranging from 4-10 wt % of the impact copolymer polypropylene composition and an amount of ethylene in the ethylene-propylene rubber phase is in a range of 35-45 mol % and a ratio of an intrinsic viscosity of the ethylene-propylene rubber phase to an intrinsic viscosity of the polymer matrix is in a range of 0.8-1.1. The composition according to the present invention is suitable for molding articles, such as containers or packaging which can be subjected to sterilization while still maintaining clarity and high impact strength.

### CROSS-REFERENCE TO RELATED APPLICATIONS

This application is a U.S. national stage application of International Application No. PCT/IB2022/055117, filed on Jun. 1, 2022, which claims priority to Thai application Ser. No. 2101003160, filed on Jun. 1, 2021. The entire contents of these applications are incorporated herein by reference in their entirety.

### TECHNICAL FIELD

Chemistry related to an impact copolymer polypropylene composition and a molded article obtained from such composition

### BACKGROUND OF THE INVENTION

Polypropylene which is widely used in the packaging application receives great attention in the molding of containers or packaging which can be subjected to sterilization. A polypropylene composition, particularly an impact copolymer polypropylene or a heterophasic polypropylene, was developed for such application which needs to maintain the clarity, impact strength, and stiffness after sterilization. Since food and drug products are usually stored at low temperature, the containers and packaging thus need to have high impact strength at low temperature.

Examples of the patent invention related to the development of an impact strength polypropylene composition are as follows.

EP 2176340 A1 discloses a heterophasic polypropylene composition which can be subjected to sterilization and has improved optical properties both before and after heat sterilization. Such composition comprises (a) a propylene homopolymer, (b) a random propylene copolymer, and a dispersed phase comprising (c) an ethylene-propylene rubber.

EP 2431416 A1 discloses a polypropylene composition having a melt flow rate (MFR) equal to or higher than 15 g/10 min. The composition comprises (a) a crystalline polypropylene matrix, (b) an elastomeric copolymer polypropylene phase, (c) a first polyethylene and (d) a second polyethylene having (i) a density higher than 915 kg/m³ and (ii) a melt flow rate equal to or higher than 30 g/10 min. Such composition provides good balance between stiffness and impact strength at low haze which is suitable for preparation of an injection molded article.

WO 2018185024 A1 discloses a soft polypropylene composition which has improved mechanical and optical properties, especially improved resistance to steam sterilization. Said composition consists of (a) a heterophasic polypropylene copolymer consisting of a matrix, which is a crystalline polypropylene homopolymer or polypropylene copolymer and an elastomeric polypropylene copolymer dispersed in the matrix; and (b) a styrene-based elastomer.

Nevertheless, regardless of various research attempting to invent and develop the impact copolymer polypropylene composition, there remains a need for a polypropylene composition which can be subjected to sterilization, and has clarity, impact strength, and stiffness suitable for molding containers or packaging for products which needs to undergo sterilization, and can be stored at low temperature as mentioned above.

### SUMMARY OF THE INVENTION

An object of the present invention is to provide an impact copolymer polypropylene composition which is suitable for molding containers or packaging for any products that needs to undergo sterilization and can be stored at low temperature.

In one aspect, the present invention relates to an impact copolymer polypropylene composition comprising:
a polymer matrix which is selected from propylene homopolymer, propylene copolymer, and a mixture thereof; and
an ethylene-propylene rubber phase dispersed in the polymer matrix,
wherein the ethylene-propylene rubber phase is in an amount of 4-10 wt % of the impact copolymer polypropylene composition and the amount of ethylene in the ethylene-propylene rubber phase is in a range of 35-45 mol % and a ratio of an intrinsic viscosity of the ethylene-propylene rubber phase to an intrinsic viscosity of the polymer matrix is in a range of 0.8-1.1.

In another aspect, the present invention relates to a molded article obtained from the impact copolymer polypropylene composition according to the present invention and to a product comprising or made of the impact copolymer polypropylene composition according to the present invention.

The impact copolymer polypropylene composition according to the present invention, the molded article, and the product comprising or made of the composition according to the present invention have clarity, stiffness, and high impact strength. The composition is suitable for the molding, especially thermoforming or injection molding, of articles, such as packaging of various products, for example, food, drug, etc., which require clarity in order to display the product contained inside. High strength and impact strength are also required for the convenient and safe storage at low temperature, for example, at 0° C. or lower. Moreover, such molded articles can still maintain clarity, stiffness, and good impact strength upon sterilization.

### DETAILED DESCRIPTION

Any aspects shown herein shall encompass the application to other aspects of the present invention, unless stated otherwise.

Technical terms and scientific terms used herein have meanings as understood by a person of ordinary skill in the art, unless specified otherwise.

Throughout the present invention, the term “about” is used to indicate that any values appearing or shown herein may be varied or deviate. Such variation or deviation may be caused by equipment error, or method used to determine the values.

The terms “consist(s) of,” “comprise(s),” “contain(s),” and “include(s)” are open-end verbs. For example, any method which “consists of,” “comprises,” “contains” or “includes” one component or multiple components or one step or multiple steps is not limited to only one component or one step or multiple steps or multiple components, but also encompasses components or steps that are not specified.

Tools, devices, methods, materials, or chemicals mentioned herein, unless specified otherwise, mean the tools, devices, methods, materials, or chemicals generally used or practiced by a person skilled in the art.

All components and/or methods disclosed and claimed in the present invention are intended to cover the aspects of the invention obtained from an action, a practice, a modification, or a change of any factors which does not require any experiment that is substantially different from the present invention and contributes to properties and utility and provides the same effect as the aspects of the present invention. According to the judgement of a person of ordinary skill in the art, although not specifically stated in the claims, substitutions, or analogues of the aspects of the present invention, including any slight modification or change that is clearly apparent to a person of ordinary skill in the art, are considered to be within the spirit, scope, and concept of the present invention as well.

### Definitions

The term “propylene homopolymer” refers to a polymer which consists essentially of repeating units derived from propylene. Propylene homopolymer may comprise repeating units derived from propylene of at least, for example, 99.0 wt %, preferably at least 99.5 wt %, more preferably at least 99.95 wt %, even more preferably at least 99.99 wt %, most preferably 100 wt %.

The term “propylene copolymer” refers to a polymer comprising repeating units derived from propylene monomer and at least one other comonomer. In general, propylene copolymer comprises, for example, at least 0.05 wt %, preferably at least 0.1 wt %, more preferably at least 0.4 wt %, of at least one other comonomer. Propylene copolymer typically does not comprise more than 15 wt % of at least one other comonomer.

The term “PE homopolymer” refers to a part which is polyethylene block present in the ethylene-propylene rubber phase which is expressed in wt % based on the total weight of the ethylene-propylene rubber phase.

The term “EPR-C2” refers to mol % of repeating units derived from ethylene (C2) in the ethylene-propylene rubber phase based on the amount of all repeating units contained therein.

The term “EPR-C3” refers to mol % of repeating units derived from propylene (C3) in the ethylene-propylene rubber phase based on the amount of all repeating units contained therein.

The term “EPR-IV” refers to the intrinsic viscosity of the ethylene-propylene rubber phase measured according to ISO1628 (in decalin) at 135° C. The term “Matrix-IV” refers to the intrinsic viscosity of a non-xylene soluble phase (polypropylene matrix).

The present invention will now be described in more detail with reference to the experiment example, which does not limit the scope of the invention in any way.

The first aspect of the present invention provides the impact copolymer polypropylene composition comprising:
the polymer matrix which is selected from propylene homopolymer, propylene copolymer, and a mixture thereof; and
the ethylene-propylene rubber phase (EPR) dispersed in the polymer matrix,
wherein the ethylene-propylene rubber phase is in an amount ranging from 4-10 wt % of the impact copolymer polypropylene composition and the amount of ethylene in the ethylene-propylene rubber phase is in a range of 35-45 mol % and the ratio of the intrinsic viscosity of the ethylene-propylene rubber phase (EPR-IV) to the intrinsic viscosity of the polymer matrix (Matrix-IV) is in a range of 0.8-1.1.

Preferably, the ethylene-propylene rubber phase is in an amount ranging from 5-10 wt % of the impact copolymer polypropylene composition.

According to the present invention, the polymer matrix may be present in an amount ranging from 90-96 wt % of the impact copolymer polypropylene composition. Preferably, the polymer matrix may be present in an amount ranging from 90-95 wt % of the impact copolymer polypropylene composition.

According to the present invention, the impact copolymer polypropylene composition comprises a propylene homopolymer matrix. Optionally, the impact copolymer polypropylene composition comprises a propylene copolymer matrix. The impact copolymer polypropylene composition also optionally comprises a mixture of propylene homopolymer and propylene copolymer matrix.

When the impact copolymer polypropylene composition comprises the propylene copolymer matrix or a mixture of propylene homopolymer and propylene copolymer matrix, the propylene copolymer comprises repeating units derived from propylene monomer and at least one other comonomer. Preferably, the comonomer is one or more olefins other than propylene. Specifically, the comonomer is one or more α-olefins. More preferably, the comonomer is selected from ethylene or C4-C8 α-olefin and a mixture thereof. Examples of the comonomer according to the present invention includes, but are not limited to, ethylene, 1-butene, 1-pentene, 1-hexene, 1-heptene, 1-octene or a mixture thereof. Preferred comonomers are ethylene, 1-butene, 1-hexene, and 1-octene. Ethylene is a highly preferred comonomer.

The polymer matrix according to the present invention has the comonomer in an amount less than or equal to 0.5 mol %. Preferably, the polymer matrix has the comonomer in an amount ranging from 0.05-0.4 mol %. On the other hand, the polymer matrix comprises the propylene copolymer which has the repeating units derived from the comonomer in an amount less than or equal to 0.5 mol %, preferably in a range of 0.05-0.4 mol %, more preferably in a range of 0.1-0.4 mol %.

The polymer matrix according to the present invention has a melt flow rate (MFR) as measured according to ASTM D1238-13 at 230° C., 2.16 kg, in a range of 0.5-30 g/10 min. Specifically, the polymer matrix comprises the propylene homopolymer or the propylene copolymer which has the melt flow rate in a range of 0.5-30 g/10 min, preferably in a range of 0.5-20 g/10 min, more preferably in a range of 2-15 g/10 min, even more preferably in a range of 2-10 g/10 min.

Moreover, the polymer matrix according to the present invention has a molecular weight distribution (MWD) in a range of 5-14. Specifically, the polymer matrix comprises the propylene homopolymer or the propylene copolymer, which has the molecular weight distribution in a range of 5-14, preferably in a range of 5-12, more preferably in a range of 6-10.

The propylene homopolymer or the propylene copolymer contained in the polymer matrix according to the present invention preferably has an isotactic tacticity of at least 94%. The tacticity has an impact on the flexural modulus of the impact copolymer polypropylene composition and the final molded article made of or comprising such composition, such as a container or a packaging. Preferably, the propylene homopolymer or the propylene copolymer contained in the polymer matrix has the isotactic tacticity of at least 95%, more preferably, at least 96%. The propylene homopolymer or the propylene copolymer contained in the polymer matrix has the isotactic tacticity in a range of 94-98%.

According to the present invention, the amount of ethylene in the ethylene-propylene rubber phase (EPR) (i.e., EPR-C2) is in a range of 35-45 mol %, preferably in a range of 35-43 mol %. Moreover, the amount of propylene in the ethylene-propylene rubber phase (EPR) (i.e., EPR-C3) is in a range of 55-65 mol %, preferably in a range of 57-65 mol %.

It is believed that the amount of ethylene-propylene rubber phase (EPR) comprised in the impact copolymer polypropylene composition has a significant impact on the mechanical properties of the composition, especially the impact strength at room temperature and low temperature. Without being bound by theory, a large amount of ethylene-propylene rubber phase (EPR) will provide a high impact strength (both at room temperature and low temperature) and a low flexural modulus. On the contrary, a small amount of ethylene-propylene rubber phase (EPR) will provide a low impact strength and a high flexural modulus. Hence, a suitable amount of ethylene-propylene rubber phase (EPR) is an important factor which must be taken into consideration when the efficiency needs to be increased in terms of impact strength and flexural modulus, as well as impact strength at low temperature, in order to achieve an overall balance of the mechanical property of the impact copolymer polypropylene composition and the molded article made of or comprising such composition.

Furthermore, it is believed that the amount of ethylene monomer in the ethylene-propylene rubber phase (EPR-C2) also plays an important role in determining the mechanical properties of the impact copolymer polypropylene composition and the molded article made of or comprising such composition. However, if a long-chain polyethylene block is formed in the ethylene-propylene rubber phase (EPR), the impact strength will be poor at both room temperature and low temperature. Therefore, the amount of ethylene-propylene rubber phase (EPR) and the amount of ethylene monomer repeating units in the ethylene-propylene rubber phase (EPR-C2) of the impact copolymer polypropylene composition of the present invention surprisingly provide balance in the impact strength property at low temperature.

Controlling the amount of ethylene in the ethylene-propylene rubber phase (EPR-C2) to be within an appropriate range does not only provide good mechanical properties in terms of stiffness and impact strength (particularly at low temperature), but also improves the appearance of obtained products, that is, no stress whitening is observed.

According to the present invention, the polyethylene block chain of the ethylene-propylene rubber phase (i.e., PE homopolymer) is present in an amount ranging from 0.3-0.8 wt %, based on the total weight of the impact copolymer polypropylene composition, as measured by 13C-NMR. The amount of polyethylene block chain of the ethylene-propylene rubber phase reflects the dispersion of the ethylene comonomer in the ethylene-propylene rubber phase and the balance between stiffness and impact strength.

Specifically, the intrinsic viscosity of the ethylene-propylene rubber phase (EPR-IV) comprised in the impact copolymer polypropylene composition is at least 1.5 dL/g, preferably in a range of 1.5-3 dL/g.

According to the present invention, the impact copolymer polypropylene composition has the melt flow rate (MFR) in a range of 2-20 g/10 min, preferable in a range of 2-14 g/10 min, more preferably in a range of 2-6 g/10 min, as measured according to ASTM D1238-D1238-13 at 230° C., 2.16 kg.

The impact copolymer polypropylene composition according to the present invention has the flexural modulus of at least 1600 MPa, as measured according to ISO 178. Such flexural modulus is suitable for various applications, especially container- or packaging-related application, such as packaging for chilled or frozen food, which requires a packaging with high mechanical strength in order to prevent damage during storage and transportation.

The impact copolymer polypropylene composition according to the present invention has a drop weight impact strength at 0° C. of at least 270 N, preferably in a range of 270-1200 N, as measured using the method described in the example to be mentioned hereinafter.

The impact copolymer polypropylene composition according to the present invention has a notched Izod impact strength at 23° C. of at least 5 KJ/m², preferably in a range of 5-10 KJ/m², as measured according to ASTM D256. The impact copolymer polypropylene composition has a notched Izod impact strength at 0° C. of at least 1 kJ/m², preferably in a range of 1-8 KJ/m², as measured according to ASTM D256.

The impact copolymer polypropylene composition according to the present invention has a heat distortion temperature of higher than 100° C., preferably in a range of 101-110° C., as measured according to ASTM D1003-illuminants C and A. Such heat distortion temperature range is advantageous for the heat treatment process during sterilization and/or the microwave properties of a packaging. Upon sterilization or microwave heating, the containers or packaging made from the composition which have high heat distortion temperature can still maintain their shapes without being denatured by the heat during such process.

The impact copolymer polypropylene composition according to the present invention has a haze less than or equal to 20%, preferably in a range of 10-20%, as measured prior to sterilization on a sheet having a thickness of 100 microns according to ASTM D 1003.

After sterilization at 121° C. for 30 minutes, the impact copolymer polypropylene composition according to the present invention still has the haze less than or equal to 20%, preferably in a range of 10-20%, as measured on a sheet having a thickness of 100 microns according to ASTM D 1003.

According to the present invention, it is found that the haze of the impact copolymer polypropylene composition before and after sterilization at 121° C. for 30 minutes is less than or equal to 20%, preferably less than or equal to 17%, based on the pre-sterilization haze. In order to obtain good properties, the clarity of the molded article, such as a packaging, which is made of or comprising the impact copolymer polypropylene composition must remain or is changed only slightly after sterilization so that it can be used as a clear food packaging as required.

The impact copolymer polypropylene composition according to the present invention may be prepared using commonly known methods. However, the impact copolymer polypropylene composition is preferably prepared using a multi-stage process, wherein each stage is performed in one or more of the same reactor or a separate reactor. Said preparation process may be a continuous, semi-continuous, or batch process, preferably a continuous process.

A process suitable for preparing the impact copolymer polypropylene composition according to the present invention comprises (consists essentially of) the steps as follows:
(i) polymerizing the propylene monomer and, optionally, the olefin comonomer to obtain the polymer matrix comprising the propylene homopolymer or the propylene copolymer, and
(ii) polymerizing the propylene monomer and the ethylene copolymer in a presence of the polymer matrix, which is propylene homopolymer or propylene copolymer or a mixture of propylene homopolymer and propylene copolymer to obtain the ethylene-propylene rubber phase (EPR) dispersed in the polymer matrix comprising the propylene homopolymer or the propylene copolymer.

The polymerization is performed using a catalyst system comprising a Ziegler-Natta catalyst. The Ziegler-Natta catalyst is preferably used in both steps (i.e., steps (i) and (ii) of the process for preparing the composition mentioned above) in conjunction with a co-catalyst, such as alkyl aluminium.

According to a preferred process for preparing the composition of the present invention, an external electron donor is added in the polymerization steps to adjust the activity and/or selectivity of the polymerization. The external electron donor added in each of the polymerization steps of propylene homopolymer or propylene copolymer (step (i)) and ethylene-propylene rubber phase (step (ii)) may be identical or different. Examples of the external electron donor which can be used in the present invention are carboxylic ester, ketone, ether, alcohol, lactone, organic phosphorus, and silicon compounds. Additionally, the external electron donor can also be alkoxysilane. Preferred external electron donors are organosilicon compounds, such as dicyclopentyl dimethoxysilane, di-isopropyl dimethoxysilane, di-isobutyl dimethoxysilane, methylcyclohexyl dimethoxysilane, n-propyl trimethoxysilane, and n-propyltriethoxysilane.

Moreover, the impact copolymer polypropylene composition according to the present invention, may comprise a modifier and/or an additive. The modifier and/or additive may be added or incorporated during the polymerization step and/or after the polymerization step through melt mixing. Examples of preferred additives include, but are not limited to, stabilizer, lubricant, nucleating agent, pigment, and foaming agent. Examples of preferred modifiers include filler (such as talc, calcium carbonate, etc.) and thermoplastic.

As an example, a preferred impact copolymer polypropylene composition of the present invention may comprise an additive in an amount ranging from 0-1 wt %.

As another example, a preferred impact copolymer polypropylene composition of the present invention may comprise a modifier in an amount ranging from 0-10 wt %.

The impact copolymer polypropylene composition of the present invention is particularly preferred for the thermoforming and/or injection molding to form a molded article, including containers or packaging for food or drug such as a clear cup for food, especially chilled or frozen food.

### Example

### Test Method

The property test of the impact copolymer polypropylene composition according to the present invention will now be described. The test method and equipment used herein are used in a general manner and are not intended to limit the scope of the invention.
1. The melt flow rate (MFR) is measured according to ASTM D1238-13 at 230° C., 2.16 kg.
2. The amounts of ethylene-propylene rubber phase (wt %) and EPR-C2 (mol %) are measured using the carbon-13 nuclear magnetic resonance spectroscopy (13C-NMR spectroscopy) technique using Bruker Ascend 500 nuclear magnetic resonance spectrometer at a carbon-13 resonance frequency of 100.4 MHz. The sample to be tested is prepared in 1,2,4-trichlorobenzene and 1,1,2,2-tetrachloroethane (d2) and measured at 120° C. An integral of each peak position is used together with the first order of Markovian Statistics and Simplex Algorithm as explained by H. N. Cheng (J. Anal. Chem. 54, 1828-1833, 1982).
3. EPR-IV (dL/g) is measured according to ISO1628 (in decalin at 135° C.). The ratio of intrinsic viscosity, or IV ratio, is the ratio of the intrinsic viscosity of the ethylene-propylene rubber phase (EPR-IV) to the intrinsic viscosity of the polymer matrix (Matrix-IV).
4. The flexural modulus is measured according to ISO 178 on a 80×10×4 mm injection-molded work piece prepared according to EN ISO 1873-2.
5. The drop weight impact strength is determined using an internal method at an additional load of 0 N at a height of 600 mm in a chamber at a temperature of 0° C. The size of the sample to be tested is 100×100 mm2, with a thickness of 2±0.02 mm.
6. The notched Izod impact strength is evaluated according to ASTM D256 at 23° C. and 0° C.
7. The heat distortion temperature is measured according to ASTM D1003-illuminants C and A.
8. The % shrinkage is measured according to ISO294-4. The % shrinkage is the measure of the size in the machine direction (MD) and the size in the transverse direction (TD) after the shrinkage caused by heat compared to the pre-test size.
9. The haze is measured according to ASTM D 1003 on a monolayer cast film having a thickness of 100 microns before and after the sterilization process at 121° C. for 30 minutes.

### Method for Preparing the Impact Copolymer Polypropylene Composition

The present invention uses chemicals which includes reactant, solvent, catalyst, and other chemicals that are commercially available.

The copolymer polypropylene composition can be prepared as follows.

Firstly, the Ziegler-Natta catalyst (Ziegler-Natta catalyst containing magnesium halide as a supporting material in an amount of 7 mg) is contacted with triethylaluminum (1 molar in hexane) and a silane compound. Then, the obtained mixture is injected into the polymerization reactor, to which 480 g liquid propylene and 11 normal liter hydrogen are added in an absence of other inert gases at 25° C., and maintained at this temperature for 10 minutes while stirring at a speed of 200 rpm. Then, the polymerization temperature is increased to 70° C. while maintaining the stirring speed at 200 rpm. The same temperature is maintained for 40 minutes. The stirrer is then stopped and the reactor pressure is reduced to atmospheric pressure. The temperature is maintained at 50° C. Then, the reactor pressure is increased with a mixture of hydrogen, ethylene, and propylene gases to a polymerization pressure of 1.2 MPa at 70° C. within 1 minute while stirring at 200 rpm. The polymerization reactor is fed with a mixture of hydrogen, ethylene, and propylene gases. The reaction is stopped by reducing the reactor pressure to atmospheric pressure.

After polymerization, the polymer is granulated, and a mixture of antioxidant and stabilizer is added. Then, the obtained polymer granules are extruded through a twin-screw extruder and dried in an oven under a nitrogen atmosphere. The sample is then analyzed as described above. The test results are shown in Table 1.

Table 1 shows the properties of the examples according to the present invention (Examples 1-3) and a comparative example (Example 4).

| | | Example | Example | Example | Example |
|---|---|---|---|---|---|
| Property | Unit | 1 | 2 | 3 | 4 |
| Melt flow rate (MFR) of the | g/10 min | 3.089 | 3.036 | 3.4 | 5.2 |
| composition | | | | | |
| Amount of ethylene- | wt % | 6.94 | 6.01 | 7.72 | 8.28 |
| propylene rubber phase | | | | | |
| (EPR) in the composition | | | | | |
| Amount of ethylene in | mol % | 40.34 | 41.79 | 37.63 | 40.96 |
| the ethylene-propylene rubber | | | | | |
| phase (EPR-C2) | | | | | |
| Ratio of intrinsic viscosity | — | 0.99 | 0.91 | 0.91 | 1.20 |
| (IV ratio) | | | | | |
| Amount of ethylene (C2) in | mol % | 0 | 0.32 | 0.34 | 0 |
| the polymer matrix | | | | | |
| Drop weight impact strength | N | 310.6 | 491.8 | 988.6 | Not |
| 0° C.: peak force | | | | | broken |
| Drop weight impact strength | J | 0.52 | 1.96 | 3.50 | Not |
| 0° C.: peak energy | | | | | broken |
| Flexural modulus | MPa | 1801 | 1738 | 1640 | 1600 |
| Heat distortion temperature | ° C. | 102.3 | 106.5 | 104.7 | 100.8 |
| (injection/0.45 MPa) | | | | | |
| Notched Izod impact strength | kJ/m² | 1.17 | 1.97 | 2.25 | 5.14 |
| at 0° C. | | | | | |
| Notched Izod impact strength | kJ/m² | 5.31 | 6.95 | 7.79 | 6.41 |
| at 23° C. | | | | | |
| Shrinkage (machine | % | 1.64/1.58 | 1.63/1.56 | 1.63/1.57 | 1.64/1.62 |
| direction/transverse direction) | | | | | |
| Pre-sterilization haze | % | 18.54 | 17.9 | 20.66 | 44.67 |
| Post-sterilization haze | % | 16.29 | 16.59 | 17.56 | 40.54 |

According to the test results, it was found that Examples 1-3 of the impact polypropylene copolymer composition prepared according to the present invention exhibit much better clarity despite being subjected to sterilization, compared to the comparative example (Example 4), and still maintain the balance between impact strength and stiffness. These are the properties required for a clear packaging, especially that for chilled food.

### BEST MODE OF THE INVENTION

Best mode of the invention is as described in the detailed description of the invention.

What is claimed is:

1. An impact copolymer polypropylene composition comprising:
a polymer matrix which is selected from propylene homopolymer, propylene copolymer, and a mixture thereof, and
an ethylene-propylene rubber phase dispersed in the polymer matrix,
wherein the ethylene-propylene rubber phase is in an amount ranging from 4-10 wt % of the impact copolymer polypropylene composition and an amount of ethylene in the ethylene-propylene rubber phase is in a range of 35-45 mol % and a ratio of an intrinsic viscosity of the ethylene-propylene rubber phase to an intrinsic viscosity of the polymer matrix is in a range of 0.8-1.1.

2. The impact copolymer polypropylene composition according to claim 1, wherein the ethylene-propylene rubber phase is in an amount ranging from 5-10 wt % of the impact copolymer polypropylene composition.

3. The impact copolymer polypropylene composition according to claim 1, wherein the polymer matrix has a molecular weight distribution (MWD) in a range of 5-14.

4. The impact copolymer polypropylene composition according to claim 1 or 3, wherein the polymer matrix has a melt flow rate (MFR) measured at 230° C., 2.16 kg, in a range of 0.5-30 g/10 min.

5. The impact copolymer polypropylene composition according to any one of claims 1 to 4, wherein the polymer matrix has a comonomer in an amount less than or equal to 0.5 mol %.

6. The impact copolymer polypropylene composition according to claim 5, wherein the comonomer is selected from ethylene, C4-C8 α-olefin, and a mixture thereof.

7. The impact copolymer polypropylene composition according to any one of claims 1 to 6 which has the melt flow rate measured at 230° C., 2.16 kg, in a range of 2-20 g/10 min.

8. The impact copolymer polypropylene composition according to claim 7 which has the melt flow rate measured at 230° C., 2.16 kg, in a range of 2-14 g/10 min.

9. The impact copolymer polypropylene composition according to any one of claims 1 to 6 which has a flexural modulus of at least 1600 MPa as measured according to EN ISO 1873-2.

10. The impact copolymer polypropylene composition according to any one of claims 1 to 6 which has a drop weight impact strength at an additional load of 0 N at a 600 mm height in a chamber having a temperature of 0° C. of at least 270 N.

11. The impact copolymer polypropylene composition according to any one of claims 1 to 6 which has a heat distortion temperature above 100° C.

12. The impact copolymer polypropylene composition according to any one of claims 1 to 6 which has a pre-sterilization haze less than or equal to 20% as measured on a sheet having a thickness of 100 microns according to ASTM D 1003.

13. The impact copolymer polypropylene composition according to any one of claims 1 to 6 which has a post-sterilization haze less than or equal to 20% as measured on a sheet having a thickness of 100 microns according to ASTM D 1003.

14. The impact copolymer polypropylene composition according to any one of claims 1 to 13 for a thermoforming or injection molding.

15. A molded article comprising the impact copolymer polypropylene composition according to any one of claims 1 to 14.

16. The molded article according to claim 15 which is a container or a packaging for food or drug.
